(19) United States
(12) Patent Application Publication
(10) Pub. No.: US 2011/0045307 A1
(43) Pub. Date: Feb. 24, 2011

(54) CERAMIC MOLDED COMPONENT OF SANDWICH CONSTRUCTION

(76) Inventor: Sigurd F. Schmidt, Calgary (CA)

Correspondence Address: NEIFELD IP LAW, PC, 4813-B EISENHOWER AVENUE, ALEXANDRIA, VA, 22304, US

(21) Appl. No.: 12/989,955

(22) PCT Filed: May 5, 2009
(86) PCT No.: PCT/CA2009/000625

§ 371 Date: Oct. 27, 2010

(30) Foreign Application Priority Data
May 5, 2008 (CA) 2,630,516

(51) Int. Cl. B32B 18/00; B32B 5/22

(52) U.S. Cl. 428/428; 428/446; 428/454

(57) ABSTRACT

The molded component consists of one or more deck layer(s) and a supporting core. This core also consists of one or more layers. The deck layer(s), as well as the core, are coated and impregnated by a ceramic matrix. The deck layers, as part of the molded component in the sandwich construction, have to take the principal stress; therefore, they have a special importance in absorbing tension, pressure, shear, torsion and bending stress. The invented molded component, with its fiber orientation preferably of±45° , will be the most efficient use of material and the best features.

### DESCRIPTION

The invention is a Ceramic Molded Component consisting of a ceramic core with deck layer(s) made of tows in ceramic matrix with quasi-isotropic features. This sandwich construction has already proven its advantages in long term practice in many fields, especially in the construction industry. For instance, in a lightweight roof construction, the truss and wall panels are made by sandwich construction. In all cases, the goal is to produce a construction with minimum weight but maximum static and dynamic load, combined with fire resistance.

Sandwich parts in building construction and in civil and underground engineering are also applied to multi-layer pipes; for instance, in sewer systems or district heating. Also, there are already bridges made of molded components with fiberglass-reinforced plastics, but the parts are still heavy.

All of these conceptually excellent constructions described above have the unappreciated but irreversible disadvantages of too-high weight and/or too little bending-tension strength, combined with too much bending of the part.

Until now it was not possible to produce modern sandwich components for challenging projects, because until now construction methods used did not include the possibility of this invention; in this sense it is a real innovation. The invention described in this document can be produced today because the necessary components now exist.

The deck-layer fiber reinforcements until now are made from fabrics, stitch-bonded fabrics, or multidirectionals of different fibers. Compared with stitch-bonded fabrics or multidirectionals, the construction and production of usual fabrics causes much higher weight, combined with only a fraction of the strength.

The reinforcement is impregnated with a ceramic matrix. For practical use of the molded component, especially under tension in different directions, the prefabricated reinforcement layers have to have a different orientation. Preferably they are arranged at an angle of±45° . In this way, the molded component is quasi-isotropic. Together with the ceramic core, the deck layers comprise the molded component. Middle reinforcements in the same±45° orientation give additional very high strength and support to the ceramic core. If needed, such reinforcements can be oriented only in a crosswise direction, to strengthen the construction part. The use of other reinforcements with quasi-isotropic features like stitch-bonding reinforcements are possible. But even usual reinforcement fabrics are possible based on their lower costs (but also lower features).

Applications of the Ceramic Molded Component described here include not only panels or boards but also many other challenging applications. For example, in the field of building construction (especially fire-resistant construction). Two other examples are the field of bridge construction and for pipes in district heating, sewers, oil pipelines in polar regions etc.

Some other applications of this invention are:
Basic materials for hanging, fire-resistant facades; double flooring; building material for entire houses
Covers for cable tunnel
Insulated pipes
Tunnel lining
Containers of all kinds
Traffic management systems
Insulated vehicles; for instance, railway cars, trucks, ships, and trailers
Quick-build road bridges
Pontoon bridges for military use
Armored vehicles, bulletproof walls, etc.

These are but a few of the potential applications.

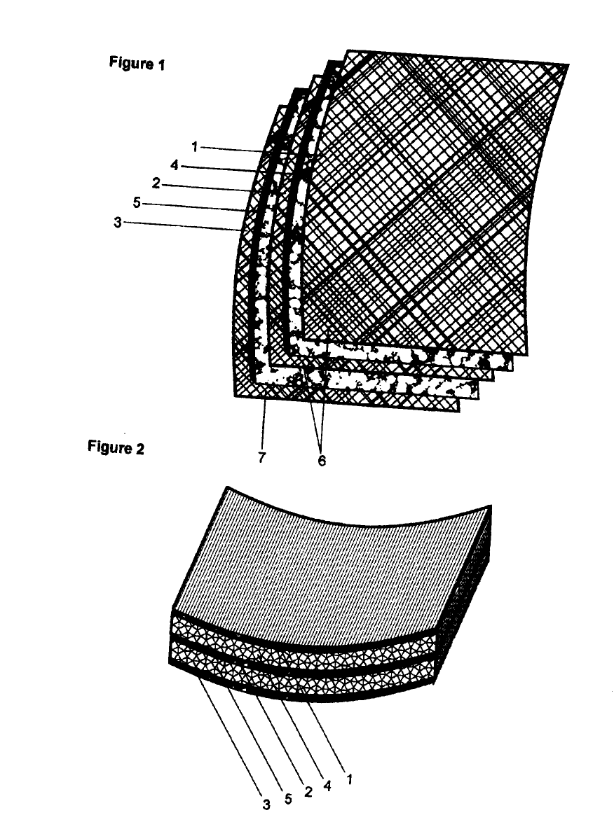

### DESCRIPTION OF FIGS. 1 AND 2 (BELOW)

1. Upper top layer made of resin-impregnated layers with reinforcement fibers;

2. Middle layer to absorb the tension transverse to the long axis of the stress direction;

3. Lower top layer, the same as the upper top layer;

4. Upper core layer made of ceramic material; for instance, expanded clay, perlite, pumice or similar;

5. Lower core layer, the same as the upper core layer;

6. Upper and middle reinforcement bundles in place;

7. Lower reinforcement bundles in place.

1. A ceramic molded component of sandwich construction including a supporting core layer having at least one reinforcing outer layer, said layer having differing fiber orientations, characterized in that said core layer is formed of ceramic material and said outer layer comprises at least two single fiber layers soaked in a ceramic matrix.

2. A component as claimed in claim 1 formed of a sandwich construction comprising a top outer layer formed of resin impregnated fiber layers soaked in a resin matrix, said core layer, and a lower, outer layer formed the same as top outer layer.

3. A component as claimed in claim 2, further including a middle layer having a similar construction to the top outer layer and lower outer layer, and a further core layer formed the same as said core layer, the middle layer and further core layer being adjacent said core layer and lower, outer, layer respectively.

4. A component as claimed in claim 1 wherein the outer layers are made of one of glass, carbon, aramid, polyester, acrylic, basalt, ceramic fibers and similar materials.

5. A component as claimed in claim 3, wherein the top, middle and lower layers are made of one of glass, carbon, aramid, polyester, acrylic, basalt, ceramic fibers and similar materials.

6. A component as claimed in claim 1, wherein at least one of said core layer and further core layer are made of a ceramic-bonded granulate based on at least one of pumice, perlite, mica, cellular glass, expanded materials, expanded clay, gravel of any kind, and the like.

7. A component as claimed in claim 1 when used as a building material.
